(19) United States
(12) Patent Application Publication
(10) Pub. No.: US 2026/0121710 A1
(43) Pub. Date: Apr. 30, 2026

(54) PERFORMING DOWNLINK OR UPLINK ANALOG BEAMFORMING COMMUNICATIONS WITH DISCRETE ANTENNAS

(71) Applicant: QUALCOMM Incorporated, San Diego, CA (US)

(72) Inventors: Vasanthan RAGHAVAN, West Windsor Township, NJ (US); Raghu Narayan CHALLA, San Diego, CA (US); Francesco GATTA, San Diego, CA (US); Arash EBADI SHAHRIVAR, San Diego, CA (US); Harish VENKATACHARI, San Jose, CA (US); Valibabu SALADI, San Diego, CA (US)

(21) Appl. No.: 18/929,953

(22) Filed: Oct. 29, 2024

(51) Int. Cl. H04B 7/06; H04L 5/00

(52) U.S. Cl. CPC H04B 7/0617; H04L 5/005

(57) ABSTRACT

Various aspects of the present disclosure generally relate to wireless communication. In some aspects, a user equipment (UE) may transmit a set of sounding reference signals (SRSs) in an uplink direction. The UE may receive a plurality of downlink reference signals in accordance with a downlink beamforming, wherein the plurality of downlink reference signals are precoded using a precoder based at least in part on the set of SRSs. The UE may perform, via one or more discrete antennas, an analog beamforming communication based at least in part on an analog downlink beam weight or an analog uplink beam weight, wherein the analog downlink beam weight is for the downlink beamforming and is based at least in part on a channel impulse response (CIR), and wherein the analog uplink beam weight is derived based at least in part on the analog downlink beam weight. Numerous other aspects are described.

### FIELD OF THE DISCLOSURE

Aspects of the present disclosure generally relate to wireless communication and specifically relate to techniques, apparatuses, and methods associated with performing downlink or uplink analog beamforming communications with discrete antennas.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless network, in accordance with the present disclosure.

FIG. 2 is a diagram illustrating an example disaggregated network node architecture, in accordance with the present disclosure.

FIG. 3 is a diagram illustrating an example associated with performing downlink or uplink analog beamforming communications with discrete antennas, in accordance with the present disclosure.

FIG. 4 is a flowchart illustrating an example process performed, for example, by a user equipment (UE), in accordance with the present disclosure.

FIG. 5 is a flowchart illustrating an example process performed, for example, by a network node, in accordance with the present disclosure.

FIGS. 6-7 are diagrams of example apparatuses for wireless communication, in accordance with the present disclosure.

### SUMMARY

In some implementations, an apparatus for wireless communication at a user equipment (UE) includes one or more memories; and one or more processors, coupled to the one or more memories, configured to cause the UE to: transmit a set of sounding reference signals (SRSs) in an uplink direction; receive a plurality of downlink reference signals in accordance with a downlink beamforming, wherein the plurality of downlink reference signals are precoded using a precoder based at least in part on the set of SRSs; and perform, via one or more discrete antennas, an analog beamforming communication based at least in part on an analog downlink beam weight or an analog uplink beam weight, wherein the analog downlink beam weight is for the downlink beamforming and is based at least in part on a channel impulse response (CIR) derived from the plurality of downlink reference signals, and wherein the analog uplink beam weight is derived based at least in part on the analog downlink beam weight.

In some implementations, an apparatus for wireless communication at a network node includes one or more memories; and one or more processors, coupled to the one or more memories, configured to cause the network node to: receive a set of SRSs in an uplink direction; transmit a plurality of downlink reference signals in accordance with a downlink beamforming, wherein the plurality of downlink reference signals are precoded using a precoder based at least in part on the set of SRSs; and perform an analog beamforming communication based at least in part on an analog downlink beam weight or an analog uplink beam weight, wherein the analog downlink beam weight is for the downlink beamforming and is based at least in part on a CIR derived from the plurality of downlink reference signals, and wherein the analog uplink beam weight is derived based at least in part on the analog downlink beam weight.

In some implementations, a method of wireless communication performed by a UE includes transmitting a set of SRSs in an uplink direction; receiving a plurality of downlink reference signals in accordance with a downlink beamforming, wherein the plurality of downlink reference signals are precoded using a precoder based at least in part on the set of SRSs; and performing, via one or more discrete antennas, an analog beamforming communication based at least in part on an analog downlink beam weight or an analog uplink beam weight, wherein the analog downlink beam weight is for the downlink beamforming and is based at least in part on a CIR derived from the plurality of downlink reference signals, and wherein the analog uplink beam weight is derived based at least in part on the analog downlink beam weight.

In some implementations, a method of wireless communication performed by a network node includes receiving a set of SRSs in an uplink direction; transmitting a plurality of downlink reference signals in accordance with a downlink beamforming, wherein the plurality of downlink reference signals are precoded using a precoder based at least in part on the set of SRSs; and performing an analog beamforming communication based at least in part on an analog downlink beam weight or an analog uplink beam weight, wherein the analog downlink beam weight is for the downlink beamforming and is based at least in part on a CIR derived from the plurality of downlink reference signals, and wherein the analog uplink beam weight is derived based at least in part on the analog downlink beam weight.

In some implementations, a non-transitory computer-readable medium storing a set of instructions for wireless communication includes one or more instructions that, when executed by one or more processors of a UE, cause the UE to: transmit a set of SRSs in an uplink direction; receive a plurality of downlink reference signals in accordance with a downlink beamforming, wherein the plurality of downlink reference signals are precoded using a precoder based at least in part on the set of SRSs; and perform, via one or more discrete antennas, an analog beamforming communication based at least in part on an analog downlink beam weight or an analog uplink beam weight, wherein the analog downlink beam weight is for the downlink beamforming and is based at least in part on a CIR derived from the plurality of downlink reference signals, and wherein the analog uplink beam weight is derived based at least in part on the analog downlink beam weight.

In some implementations, a non-transitory computer-readable medium storing a set of instructions for wireless communication includes one or more instructions that, when executed by one or more processors of a network node, cause the network node to: receive a set of SRSs in an uplink direction; transmit a plurality of downlink reference signals in accordance with a downlink beamforming, wherein the plurality of downlink reference signals are precoded using a precoder based at least in part on the set of SRSs; and perform an analog beamforming communication based at least in part on an analog downlink beam weight or an analog uplink beam weight, wherein the analog downlink beam weight is for the downlink beamforming and is based at least in part on a CIR derived from the plurality of downlink reference signals, and wherein the analog uplink beam weight is derived based at least in part on the analog downlink beam weight.

In some implementations, an apparatus for wireless communication includes means for transmitting a set of SRSs in an uplink direction; means for receiving a plurality of downlink reference signals in accordance with a downlink beamforming, wherein the plurality of downlink reference signals are precoded using a precoder based at least in part on the set of SRSs; and means for performing, via one or more discrete antennas, an analog beamforming communication based at least in part on an analog downlink beam weight or an analog uplink beam weight, wherein the analog downlink beam weight is for the downlink beamforming and is based at least in part on a CIR derived from the plurality of downlink reference signals, and wherein the analog uplink beam weight is derived based at least in part on the analog downlink beam weight.

In some implementations, an apparatus for wireless communication includes means for receiving a set of SRSs in an uplink direction; means for transmitting a plurality of downlink reference signals in accordance with a downlink beamforming, wherein the plurality of downlink reference signals are precoded using a precoder based at least in part on the set of SRSs; and means for performing an analog beamforming communication based at least in part on an analog downlink beam weight or an analog uplink beam weight, wherein the analog downlink beam weight is for the downlink beamforming and is based at least in part on a CIR derived from the plurality of downlink reference signals, and wherein the analog uplink beam weight is derived based at least in part on the analog downlink beam weight.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Analog beamforming may involve the use of phase shifters and/or amplitude control to co-phase antenna elements at RF or in an analog domain. Analog beamforming may typically be used in frequency range two (FR2) frequencies for improving a link budget of an mmWave system that is impaired with blockage/penetration and/or an increased path loss. FR2 may range from 24.25 gigahertz (GHz) to 52.6 GHz. An FR2 based antenna system may include one or more antenna modules or one or more antenna panels. An antenna module may include a dual polarized antenna phased array. The antenna module may be associated with an antenna array, such as a 5×1 antenna array (e.g., five antenna elements in the antenna array).

Analog beamforming may be extended for use in frequency range one (FR1) frequencies. FR1 may range from 0.4 GHz to 7.125 GHz. An FR1-based antenna system may include a plurality of discrete (monopole or planar inverted-F) antennas. A discrete antenna may be a single polarized antenna that is implemented within a user equipment (UE) frame and/or housing. The discrete antenna may communicate over one polarization due to a lack of sufficient space for dual-polarized systems.

Analog beamforming is not used at FR1 frequencies and extending analog beamforming to the FR1 frequencies may be associated with various challenges. FR1 may use discrete, monopole antennas that are typically single polarized. FR1 antennas may often be placed along a UE's surface without any specific analog beamforming oriented design criteria. Rather, placing FR1 antennas may involve minimizing correlations or identifying favorable locations on the UE where the FR1 antennas can be placed without interfering with other coexisting antennas. The FR1 antennas may become impacted by a UE housing, a sensor, a camera, and/or a battery more than FR2 antennas due to distributed locations of the FR1 antennas. The FR1 antennas may be intended to be designed to be omni-directional (which is often the case for frequencies greater than 1 GHz), but the FR1 antennas may tend to be less omni-directional in behavior as the frequency increases (e.g., C-band or 3.8 GHz). Further, FR1 network nodes may be associated with massive/giga MIMO, which may be associated with 64 transceiver units (TXRUs), denoted as 64TR64R, or 32 TXRUs, denoted as 32TR. A higher number of antenna elements tied to these 64 or 32 (or more) TXRUs, may lead to channel hardening or singular value decomposition (SVD) precoders converging to their statistical variants often independent of channel realization. As a result, a UE and/or a network node may not be properly configured to apply analog beamforming to the FR1 frequencies. Without the analog beamforming applied to the FR1 frequencies, an FR1-based wireless communication system that is impaired with blockage/penetration and/or an increased path loss may suffer from a degraded link budget (a calculation of total gain and loss in a wireless communication system), thereby degrading an overall system performance.

Various aspects relate generally to analog beamforming. Some aspects more specifically relate to performing downlink or uplink analog beamforming communications with discrete antennas. In some examples, a UE may transmit, to a network node, a set of sounding reference signals (SRSs) or other types of uplink reference signals in an uplink direction. The UE may receive, from the network node, a plurality of downlink reference signals in accordance with a downlink beamforming.

The plurality of downlink reference signals may be precoded by the network node based at least in part on the set of SRSs received from the UE. The UE may perform, via one or more discrete antennas, an analog beamforming communication based at least in part on an analog downlink beam weight or an analog uplink beam weight. The analog downlink beam weight may be for the downlink beamforming and may be based at least in part on a channel impulse response (CIR) derived from the plurality of downlink reference signals. The analog uplink beam weight may be derived based at least in part on the analog downlink beam weight. The analog beamforming communication may be a downlink or an uplink analog beamforming communication using discrete antennas of the UE. For example, the analog beamforming communication may be via one or more FR1-style antennas associated with the UE. Alternatively, the analog beamforming communication may be via one or more FR1-style antennas associated with the UE, where the one or more FR1-style antennas may be at a frequency range three (FR3).

Particular aspects of the subject matter described in this disclosure can be implemented to realize one or more of the following potential advantages. In some examples, by enabling the UE to determine the analog downlink beam weight and/or the analog uplink beam weight, the described techniques can be used to support analog beamforming when the UE utilizes discrete antennas. The UE may determine the analog downlink beam weight and/or the analog uplink beam weight based at least in part on a constructive beam weight learning, which may allow the UE and the network to perform analog beamforming communications with each other using the analog downlink beam weight and/or the analog uplink beam weight. The UE may support the analog beamforming in FR1 frequencies using FR1-style, discrete antennas, and/or the UE may support the analog beamforming in FR3 frequencies using the FR1-style, discrete antennas, in addition to supporting the analog beamforming in FR2 frequencies. When enabling the UE to support analog beamforming for both an uplink and a downlink for FR1 frequencies, an overall link budget in a wireless communication system may be improved when the wireless communication system is impaired with a blockage/penetration and/or an increased path loss, thereby improving an overall system performance.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

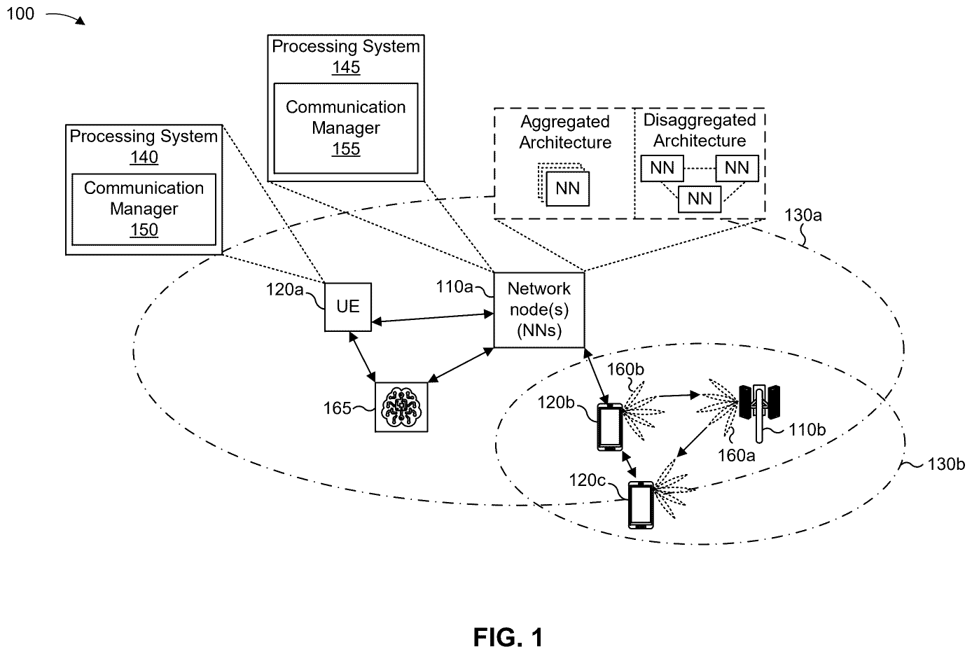

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein.

Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

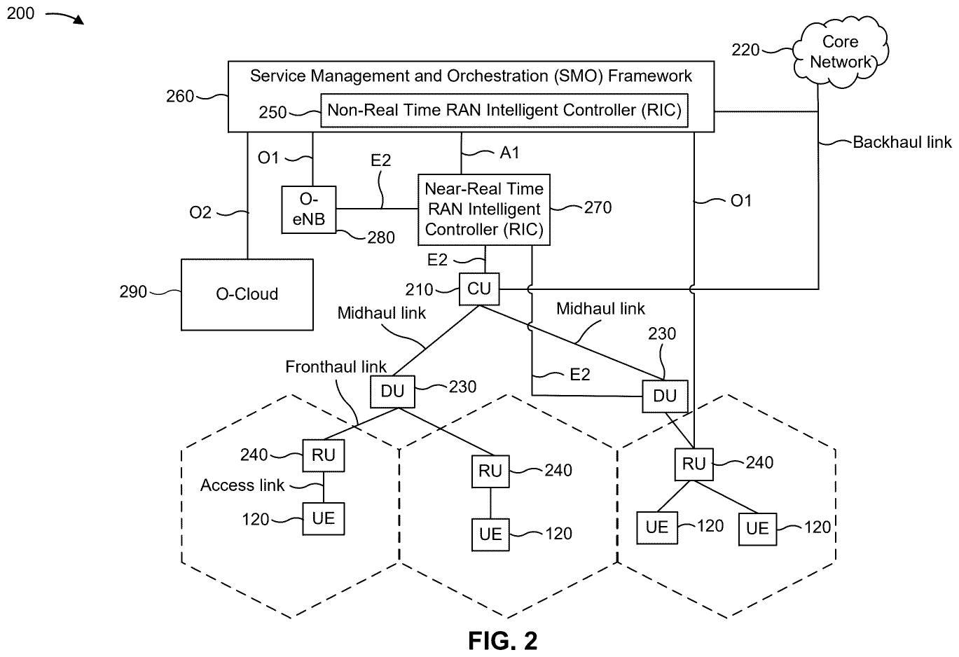

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains information that allows the UE 120 to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include an SRS, a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, a network node 110 and/or UEs 120). For example, the one or more devices 165 may include a UE 120 (for example, the processing system 140), a network node 110 (for example, the processing system 145), one or more servers, and/or one or more components of a cloud computing network, among other examples. In some examples, the AI/ML model (or an instance of the AI/ML model) may be deployed at multiple devices (for example, a first portion of the AI/ML model may be deployed at a UE 120 and a second portion of the AI/ML model may be deployed at a network node 110). In other examples, a first AI/ML model may be deployed at a UE 120 and a second AI/ML model may be deployed at a network node 110. The AI/ML model(s) may be configured to enhance various aspects of the wireless communication network 100. For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

In some aspects, a UE (e.g., the UE 120) may include a communication manager 150. As described in more detail elsewhere herein, the communication manager 150 may transmit a set of SRSs in an uplink direction; receive a plurality of downlink reference signals in accordance with a downlink beamforming, wherein the plurality of downlink reference signals are precoded using a precoder based at least in part on the set of SRSs; and perform, via one or more discrete antennas, an analog beamforming communication based at least in part on an analog downlink beam weight or an analog uplink beam weight, wherein the analog downlink beam weight is for the downlink beamforming and is based at least in part on a CIR derived from the plurality of downlink reference signals, and wherein the analog uplink beam weight is derived based at least in part on the analog downlink beam weight. Additionally, or alternatively, the communication manager 150 may perform one or more other operations described herein.

In some aspects, a network node (e.g., the network node 110) may include a communication manager 155. As described in more detail elsewhere herein, the communication manager 155 may receive a set of SRSs in an uplink direction; transmit a plurality of downlink reference signals in accordance with a downlink beamforming, wherein the plurality of downlink reference signals are precoded using a precoder based at least in part on the set of SRSs; and perform an analog beamforming communication based at least in part on an analog downlink beam weight or an analog uplink beam weight, wherein the analog downlink beam weight is for the downlink beamforming and is based at least in part on a CIR derived from the plurality of downlink reference signals, and wherein the analog uplink beam weight is derived based at least in part on the analog downlink beam weight. Additionally, or alternatively, the communication manager 155 may perform one or more other operations described herein.

As indicated above, FIG. 1 is provided as an example. Other examples may differ from what is described with regard to FIG. 1.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

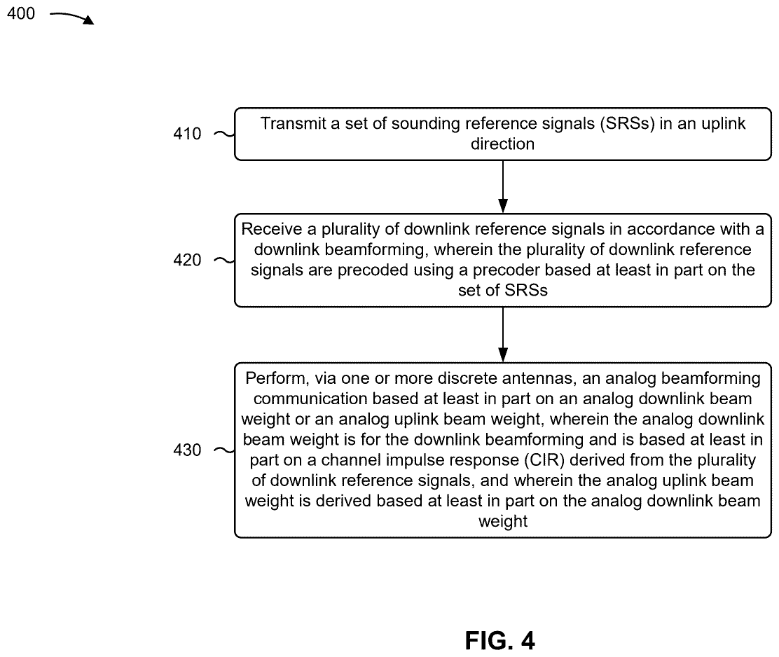

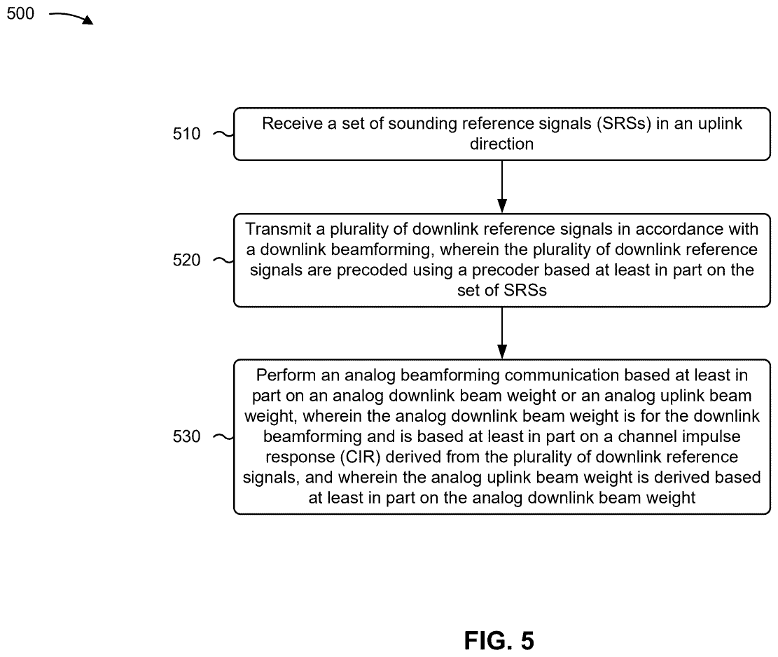

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with performing downlink or uplink analog beamforming communications with discrete antennas, as described in more detail elsewhere herein. For example, the processing system 145 of the network node 110, the processing system 140 of the UE 120, the CU 210, the DU 230, or the RU 240 may perform or direct operations of, for example, process 400 of FIG. 4, process 500 of FIG. 5, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 400 of FIG. 4, process 500 of FIG. 5, or other processes as described herein. In some examples, executing instructions may include running the instructions, converting the instructions, compiling the instructions, and/or interpreting the instructions, among other examples.

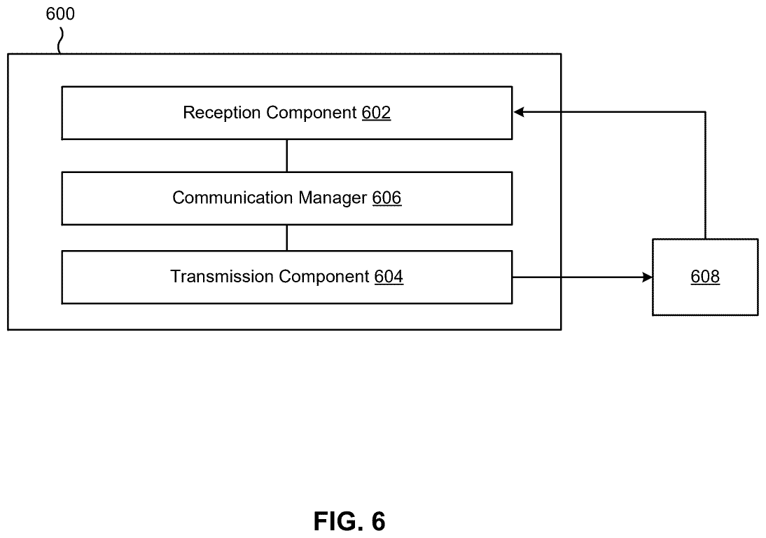

In some aspects, a UE (e.g., the UE 120) includes means for transmitting a set of SRSs in an uplink direction; means for receiving a plurality of downlink reference signals in accordance with a downlink beamforming, wherein the plurality of downlink reference signals are precoded using a precoder based at least in part on the set of SRSs; and/or means for performing, via one or more discrete antennas, an analog beamforming communication based at least in part on an analog downlink beam weight or an analog uplink beam weight, wherein the analog downlink beam weight is for the downlink beamforming and is based at least in part on a CIR derived from the plurality of downlink reference signals, and wherein the analog uplink beam weight is derived based at least in part on the analog downlink beam weight. The means for the UE to perform operations described herein may include, for example, one or more of communication manager 150, processing system 140, a radio, one or more RF chains, one or more transceivers, one or more antennas, one or more modems, a reception component (for example, reception component 602 depicted and described in connection with FIG. 6), and/or a transmission component (for example, transmission component 604 depicted and described in connection with FIG. 6), among other examples.

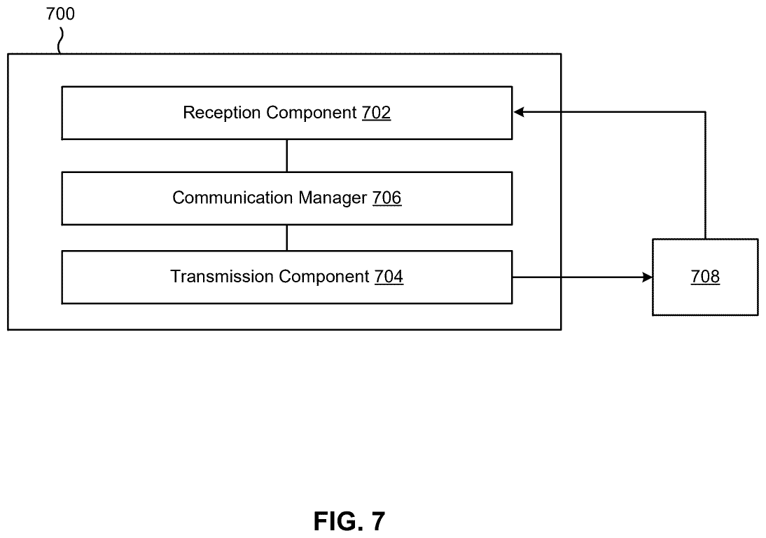

In some aspects, a network node (e.g., the network node 110) includes means for receiving a set of SRSs in an uplink direction; means for transmitting a plurality of downlink reference signals in accordance with a downlink beamforming, wherein the plurality of downlink reference signals are precoded using a precoder based at least in part on the set of SRSs; and/or means for performing an analog beamforming communication based at least in part on an analog downlink beam weight or an analog uplink beam weight, wherein the analog downlink beam weight is for the downlink beamforming and is based at least in part on a CIR derived from the plurality of downlink reference signals, and wherein the analog uplink beam weight is derived based at least in part on the analog downlink beam weight. The means for the network node to perform operations described herein may include, for example, one or more of communication manager 155, processing system 145, a radio, one or more RF chains, one or more transceivers, one or more antennas, one or more modems, a reception component (for example, reception component 702 depicted and described in connection with FIG. 7), and/or a transmission component (for example, transmission component 704 depicted and described in connection with FIG. 7), among other examples.

As indicated above, FIG. 2 is provided as an example. Other examples may differ from what is described with regard to FIG. 2.

Analog beamforming may involve the use of phase shifters and/or amplitude control to co-phase antenna elements at an RF. Analog beamforming may typically be used in FR2 (mmWave) frequencies for improving a link budget of an mmWave system that is impaired with blockage/penetration and/or an increased path loss. FR2 may range from 24.25 GHz to 52.6 GHz. An FR2 based antenna system may include one or more antenna modules or one or more antenna panels. An antenna module may include a dual polarized antenna phased array. The antenna module may be associated with an antenna array, such as a 2×1 antenna array (e.g., two antenna elements in the antenna array).

Analog beamforming may be extended for use in FR1 frequencies. FR1 may range from 0.4 GHz to 7.125 GHz. An FR1-based antenna system may include a plurality of discrete (monopole) antennas. A discrete antenna may be a single polarized antenna that is implemented within a UE frame and/or housing. The discrete antenna may communicate over one polarization due to a lack of sufficient space for dual-polarized systems.

However, extended analog beamforming to the FR1 frequencies may be associated with various challenges. FR1 may use discrete, monopole antennas that are typically single polarized. FR1 antennas may often be placed along a UE's surface without any specific analog beamforming oriented design criteria. Rather, placing FR1 antennas may involve minimizing correlations or identifying favorable locations on the UE where the FR1 antennas can be placed without interfering with other coexisting antennas. The FR1 antennas may become impacted by a UE housing, a sensor, a camera, and/or a battery more than FR2 antennas due to distributed locations of the FR1 antennas. The FR1 antennas may be intended to be designed to be omni-directional (which is often the case for frequencies greater than 1 GHz), but the FR1 antennas may tend to be less omni-directional in behavior as the frequency increases (e.g., C-band or 3.8 GHz). Further, FR1 network nodes may be associated with massive/giga MIMO, which may be associated with 64T64R or 32T32R. A higher number of antenna elements tied to 64T64R or 32T32R TXRUs may lead to channel hardening or SVD precoders converging to their statistical variants often independent of channel realization. As a result, a UE and/or a network node may not be properly configured to apply analog beamforming to the FR1 frequencies. Without the analog beamforming applied to the FR1 frequencies, an FR1-based wireless communication system that is impaired with blockage/penetration and/or an increased path loss may suffer from a degraded link budget (a calculation of total gain and loss in a wireless communication system), thereby degrading an overall system performance.

In various aspects of techniques and apparatuses described herein, a UE may transmit, to a network node, a set of SRSs or other types of uplink reference signals in an uplink direction. The UE may receive, from the network node, a plurality of downlink reference signals (e.g., DMRSs, CSI-RSs, or SSBs) in accordance with a downlink beamforming. The plurality of downlink reference signals may be precoded by the network node based at least in part on the set of SRSs received from the UE. The UE may perform, via one or more discrete antennas, an analog beamforming communication based at least in part on an analog downlink beam weight or an analog uplink beam weight. The analog downlink beam weight may be for the downlink beamforming and may be based at least in part on a CIR derived from the plurality of downlink reference signals. The analog uplink beam weight may be derived based at least in part on the analog downlink beam weight. The analog beamforming communication may be a downlink or an uplink analog beamforming communication using discrete antennas of the UE. For example, the analog beamforming communication may be via one or more FR1-style antennas associated with the UE. Alternatively, the analog beamforming communication may be via one or more FR1-style antennas associated with the UE, where the one or more FR1-style antennas may be at an FR3. FR3 may range from 7.125 GHz to 24.25 GHz. In some aspects, analog beamforming with FR1 antennas may be employed in UE modems to assist with power-performance tradeoffs. The analog beamforming may be enabled on a downlink and an uplink for discrete FR1 antennas. The analog beamforming may also be extended to FR1-style antennas at FR3 (e.g., 7-8 GHz, or 13-15 GHz).

In some aspects, analog beamforming may be extended to FR1 frequencies based at least in part on a constructive beam weight learning, where challenges associated with extended the analog beamforming to FR1 frequencies may be overcome with the constructive beam weight learning. The analog beamforming may be performed on a downlink and on an uplink with discrete FR1 antennas. The UE may sound up to two parts on the uplink, with or without analog beamforming, such that the network node is able to learn an SVD precoder. The network node may perform a downlink beamforming with the SVD precoder over downlink reference signals (e.g., DMRSs, CSI-RSs, or SSBs). The UE may learn a channel impulse response (CIR) over the downlink reference signals. The network node may perform the downlink beamforming over the downlink reference signals based at least in part on a downlink reference signal configuration and periodicity, which may be configured by the network node based at least in part on a UE reporting or recommendation. The UE may determine analog beam weights for the downlink beamforming based at least in part on the CIR. The UE may use the analog beam weights for the downlink. The UE may perform a beam weight adjustment for the uplink based at least in part on a lookup table, and then the UE may use the beam weight adjustment on the uplink. For example, the UE may look up the analog beam weights for the downlink in the lookup table to obtain a corresponding beam weight adjustment for the uplink. By obtaining the analog beam weights for the downlink and the beam weight adjustment for the uplink, the analog beamforming on the downlink and on the uplink may be achieved with the discrete FR1 antennas, thereby improving an overall system performance.

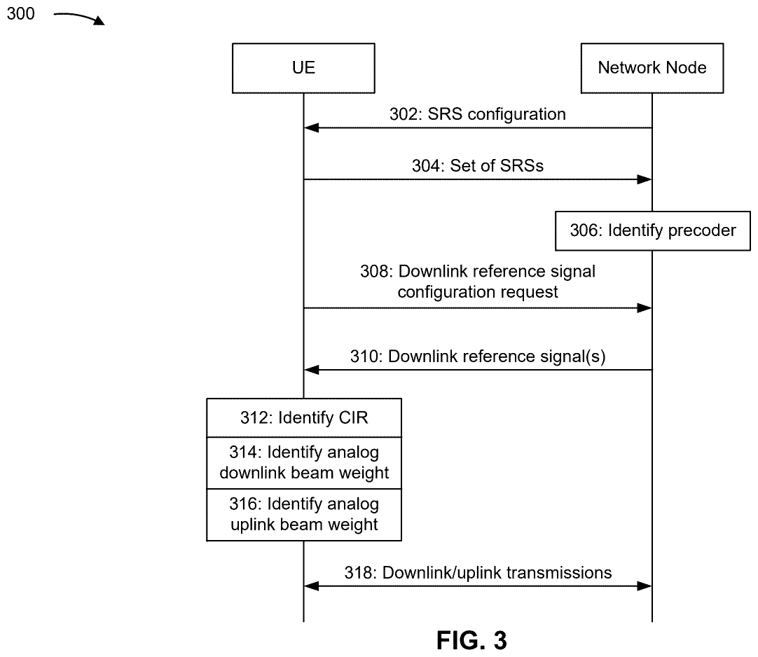

FIG. 3 is a diagram illustrating an example 300 associated with performing downlink or uplink analog beamforming communications with discrete antennas, in accordance with the present disclosure. As shown in FIG. 3, example 300 includes communication between a UE (e.g., UE 120) and a network node (e.g., network node 110). In some aspects, the UE and the network node may be included in a wireless network, such as wireless network 100.

As shown by reference number 302, the UE may receive, from the network node, an SRS configuration. The SRS configuration may indicate an SRS periodicity. The SRS periodicity may be for a set of SRSs or other types of uplink reference signals that are transmitted in an uplink direction from the UE to the network node. The SRS periodicity may be based at least in part on a dynamic of a channel between the UE and the network node. For example, depending on the dynamic of the channel, the SRS periodicity may be increased or decreased accordingly. The SRS configuration may indicate a number of ports for transmitting the set of SRSs. The SRS configuration may indicate available resources for transmitting the set of SRSs.

As shown by reference number 304, the UE may transmit the set of SRSs to the network node. The UE may transmit the set of SRSs in accordance with the SRS configuration. For example, the UE may transmit the set of SRSs in accordance with the SRS periodicity, the number of ports, and/or the available resources, based at least in part on the SRS configuration. The UE may transmit the set of SRSs in the uplink direction to the network node. The UE may transmit the set of SRSs with analog beamforming. For example, when analog beamforming is employed, the UE may use phase shifters and/or amplitude control to co-phase antenna elements at an RF. Alternatively, the UE may transmit the set of SRSs without analog beamforming. In this case, when the analog beamforming is not employed, the UE may not use any phase shifters and/or amplitude control to co-phase antenna elements at the RF. In other words, an SRS transmission in the uplink direction may be with or without the analog beamforming.

As shown by reference number 306, the network node may identify a precoder, which may be based at least in part on the set of SRSs received from the UE. The network node may learn the precoder (or multiple precoders) based at least in part on the set of SRSs received from the UE. The precoder may be an SVD precoder. The precoder may be associated with an optimal beam weight, where the optimal beam weight may be based at least in part on phase shifter and/or amplitude control combinations. The network node, based at least in part on the set of SRSs, may evaluate various parameters, such as a path loss, a propagation delay, and/or a received signal strength to identify a channel condition between the network node and the UE. Depending on the various parameters, the network node may select the precoder accordingly.

In some aspects, analog beamforming may lead to power-performance tradeoffs at FR1/FR3 frequencies. In order to implement the analog beamforming at the FR1/FR3 frequencies, the UE may learn optimal beam weights to be used over antenna elements at an RF. The optimal beam weights may refer to phase shifter and/or amplitude control combinations. Optimal beam weights at the network node may be one or more precoders over an optimal rank selected by the network node. The one or more precoders may include SVD precoders. Optimal beam weights at the UE may be matched to a CIR observed by the UE over subcarriers of interest. As a channel becomes more frequency non-selective, a single set of analog beamforming weights may be sufficient to match a performance at the UE. As the channel becomes more frequency selective, optimal analog beamforming weights may be determined.

In some aspects, the UE may be configured to periodically transmit SRSs over a certain number of SRS ports (e.g., one SRS port or two SRS ports). The set of SRSs may allow the network node to learn the precoder (e.g., the SVD precoder) for network node communications. The network node may be associated with a massive MIMO scheme. The precoder learned by the network node may include top-K singular vectors of a channel between the network node and the UE. A periodicity of the set of SRSs may be configured by the network node based at least in part on network-node-to-UE channel dynamics. In one example, the UE may use a single antenna per SRS port. Alternatively, the UE may use multiple antennas that are analog beamformed over each SRS port.

As shown by reference number 308, the UE may transmit, to the network node, a downlink reference signal configuration request. The downlink reference signal configuration request may be a DMRS configuration request, a CSI-RS configuration request, or an SSB configuration request. The downlink reference signal configuration request may be based at least in part on the channel condition and an uplink-downlink channel disparity (e.g., a number of uplink channels versus a number of downlink channels). The downlink reference signal configuration request may indicate a number of downlink reference signal ports (e.g., DMRS ports or CSI-RS ports) and/or a requested downlink reference signal periodicity (e.g., a requested DMRS periodicity, a requested CSI-RS periodicity, or a requested SSB periodicity). The UE may transmit the downlink reference signal configuration request in order to recommend or report a downlink reference signal configuration to the network node. In other words, the UE may report the downlink reference signal configuration request (e.g., the number of downlink reference signal ports and/or a downlink reference signal periodicity) based at least in part on the channel condition and/or the uplink-downlink channel disparity.

As shown by reference number 310, the UE may receive, from the network node, a plurality of downlink reference signals in accordance with a downlink beamforming. The plurality of downlink reference signals may include a plurality of DMRSs, a plurality of CSI-RSs, or a plurality of SSBs. The plurality of downlink reference signals may be precoded using the precoder based at least in part on the set of SRSs. The UE may receive the plurality of downlink reference signals in accordance with the downlink reference signal configuration, where the downlink reference signal configuration may be based at least in part on the downlink reference signal configuration request. The network node may transmit the plurality of downlink reference signals in accordance with the precoder. In other words, the network node may configure downlink reference signals using the precoder learned from the set of SRSs. The downlink reference signals may enable the UE to learn an analog downlink beam weight and an analog uplink beam weight, which may be used for subsequent downlink/uplink transmissions between the UE and the network node.

As shown by reference number 312, the UE may identify the CIR associated with the plurality of downlink reference signals. The UE may derive the CIR based at least in part on the plurality of downlink reference signals. The CIR may indicate a modeling of the downlink reference signals as the downlink reference signals travel through the channel between the network node and the UE. The CIR may be affected by a path loss between the UE and the network node. The CIR may be affected by a delay spread. The CIR may be affected by an angle of arrival of the downlink reference signals. The CIR may reflect the plurality of downlink reference signals received from the network node, where the plurality of downlink reference signals may be associated with the downlink beamforming performed by the network node.

As shown by reference number 314, the UE may identify the analog downlink beam weight (or multiple analog downlink beam weights) for the downlink beamforming based at least in part on the CIR. In other words, the UE may first learn the CIR from the plurality of downlink reference signals, and then the UE may determine the analog downlink beam weight from the CIR. The analog downlink beam weight may be a parameter that adjusts a direction and/or a shape of beams in a downlink direction. The analog downlink beam weight may be based at least in part on downlink channel characteristics, where the downlink channel characteristics may be reflected by the CIR.

As shown by reference number 316, the UE may identify the analog uplink beam weight (or multiple analog uplink beam weights). The UE may identify the analog uplink beam weight based at least in part on the analog downlink beam weight. For example, the UE may look up the analog downlink beam weight in a lookup table, and from the lookup table, the UE may identify the analog uplink beam weight that corresponds with the analog downlink beam weight. In other words, the lookup table may define a mapping of analog downlink beam weights and corresponding analog uplink beam weights. In one example, the UE may identify a beam weight adjustment for the uplink direction (e.g., from the lookup table), where the beam weight adjustment may be performed to derive the analog uplink beam weight. Thus, the UE may learn downlink/uplink beam weights for analog beamforming.

In some aspects, for the UE to determine analog beamforming weights, the UE may learn the CIR over all antennas and all subcarriers of interest at the UE, such that the antennas and/or the subcarriers are able to be analog beamformed as appropriate.

For the uplink direction, analog downlink beam weights may be used and adjusted to capture inter-antenna spacings between different antenna elements. An antenna environment between antennas may depend on a UE design, as a housing and a placement of objects, such as a battery, a camera, a sensor, and/or a power grid may be original equipment manufacturer (OEM)-dependent. Such components may have different thermal/power gradients over time, which may lead to different/dynamic impact of phase shifters and/or amplitude control settings. In addition to compensating for uplink-downlink circuit mismatches (which may be done with calibration or characterization), the plurality of downlink reference signals may be used to track uplink channels in FR1. Even in a zero mobility FR1 channel, the plurality of downlink reference signals may be used to track analog uplink beam weights due to a distributed nature of antenna elements in FR1.

In some aspects, to learn analog beam weights (beam weights for analog beamforming) on a downlink direction and/or the uplink direction, the UE may recommend or report the downlink reference signal configuration (e.g., the number of downlink reference signal ports and/or the downlink reference signal periodicity). A periodicity of the downlink reference signal configuration for downlink beam learning may depend on the network node and UE channel dynamics, as well as power/thermal gradients between FR1 antenna elements and an impact of the power/thermal gradients on phase shifter and/or amplitude control behavior over time. The network node may configure downlink reference signal ports for the UE to learn the CIR based at least in part on the recommendation/reporting from the UE. In other words, the network node may configure the plurality of downlink reference signals to enable the UE to learn the analog downlink beam weight and the adjustment for the analog uplink beam weight. The UE may learn the downlink/uplink beam weights for analog beamforming based at least in part on the plurality of downlink reference signals received from the network node.

As shown by reference number 318, the UE and/or the network node may perform an analog beamforming communication based at least in part on the analog downlink beam weight or the analog uplink beam weight, where the analog downlink beam weight may be for the downlink beamforming and may be based at least in part on the CIR derived from the plurality of downlink reference signals, and where the analog uplink beam weight may be based at least in part on the analog downlink beam weight. In one example, the UE may receive, from the network node, a downlink transmission, with the analog beamforming or without the analog beamforming, based at least in part on the analog downlink beam weight. In another example, the UE may transmit, to the network node, an uplink transmission, with the analog beamforming or without the analog beamforming, based at least in part on the analog uplink beam weight. The analog beamforming communication may be via one or more discrete FR1-based antennas associated with the UE. Alternatively, the analog beamforming communication may be via one or more discrete FR1-based antennas associated with the UE, and the one or more FR1-style antennas may be at an FR3.

In some aspects, based at least in part on a determination of downlink and uplink analog beamforming beam weights, and based at least in part on the precoder learned by the network node from the set of SRSs, the UE and the network node may establish analog beamforming communications on the downlink direction and/or on the uplink direction. In some cases, downlink communications may be with or without the analog beamforming. Similarly, uplink communications may be with or without the analog beamforming. When the analog beamforming is employed, the UE may transmit uplink transmissions in accordance with the uplink analog beamforming beam weight. Similarly, when the analog beamforming is employed, the UE may receive downlink transmissions based at least in part on the downlink analog beamforming beam weight.

In some aspects, analog beamforming in FR1 with a clustered delay line (CDL) channel may be associated with various performance benefits. Analog beamforming only for downlink communications may show a gain of up to approximately 15% over a baseline scheme of two transmit antenna elements and two receive antenna elements (2T2R) with no analog beamforming across delay spreads. Analog beamforming for sounding/uplink communications to assist with a network node precoder learning and analog beamforming for downlink communications may show a gain of up to approximately 25% over the baseline scheme of 2T2R with no analog beamforming across delay spreads. A performance gain may generally increase across schemes as a delay spread decreases and as a channel becomes more frequency non-selective.

As indicated above, FIG. 3 is provided as an example. Other examples may differ from what is described with regard to FIG. 3.

FIG. 4 is a diagram illustrating an example process 400 performed, for example, at a UE or an apparatus of a UE, in accordance with the present disclosure. Example process 400 is an example where the apparatus or the UE (e.g., UE 120) performs operations associated with performing downlink or uplink analog beamforming communications with discrete antennas.

As shown in FIG. 4, in some aspects, process 400 may include transmitting a set of SRSs in an uplink direction (block 410). For example, the UE (e.g., using transmission component 604 and/or communication manager 606, depicted in FIG. 6) may transmit a set of SRSs in an uplink direction, as described above.

As further shown in FIG. 4, in some aspects, process 400 may include receiving a plurality of downlink reference signals in accordance with a downlink beamforming, wherein the plurality of downlink reference signals are precoded using a precoder based at least in part on the set of SRSs (block 420). For example, the UE (e.g., using reception component 602 and/or communication manager 606, depicted in FIG. 6) may receive a plurality of downlink reference signals in accordance with a downlink beamforming, wherein the plurality of downlink reference signals are precoded using a precoder based at least in part on the set of SRSs, as described above.

As further shown in FIG. 4, in some aspects, process 400 may include performing, via one or more discrete antennas, an analog beamforming communication based at least in part on an analog downlink beam weight or an analog uplink beam weight, wherein the analog downlink beam weight is for the downlink beamforming and is based at least in part on a CIR derived from the plurality of downlink reference signals, and wherein the analog uplink beam weight is derived based at least in part on the analog downlink beam weight (block 430). For example, the UE (e.g., using communication manager 606, depicted in FIG. 6) may perform, via one or more discrete antennas, an analog beamforming communication based at least in part on an analog downlink beam weight or an analog uplink beam weight, wherein the analog downlink beam weight is for the downlink beamforming and is based at least in part on a CIR derived from the plurality of downlink reference signals, and wherein the analog uplink beam weight is derived based at least in part on the analog downlink beam weight, as described above.

Process 400 may include additional aspects, such as any single aspect or any combination of aspects described below and/or in connection with one or more other processes described elsewhere herein.

In a first aspect, process 400 includes receiving an SRS configuration that indicates an SRS periodicity, wherein the SRS periodicity is based at least in part on a dynamics of a channel between the UE and a network node, and the set of SRSs are transmitted in accordance with the SRS configuration.

In a second aspect, alone or in combination with the first aspect, the set of SRSs are transmitted with analog beamforming.

In a third aspect, alone or in combination with one or more of the first and second aspects, the set of SRSs are transmitted without analog beamforming.

In a fourth aspect, alone or in combination with one or more of the first through third aspects, process 400 includes transmitting a downlink reference signal configuration request based at least in part on a channel condition and an uplink-downlink channel disparity, wherein the downlink reference signal configuration request indicates a number of ports and a requested periodicity, wherein the plurality of downlink reference signals are received in accordance with a downlink reference signal configuration, and the downlink reference signal configuration is based at least in part on the downlink reference signal configuration request.

In a fifth aspect, alone or in combination with one or more of the first through fourth aspects, process 400 includes identifying the CIR associated with the plurality of downlink reference signals, identifying the analog downlink beam weight for the downlink beamforming based at least in part on the CIR, wherein the analog downlink beam weight is associated with the analog beamforming communication on a downlink, and identifying, from a lookup table or using an uplink-downlink calibration procedure, the analog uplink beam weight based at least in part on the analog downlink beam weight, wherein the analog uplink beam weight is associated with the analog beamforming communication on an uplink.

In a sixth aspect, alone or in combination with one or more of the first through fifth aspects, process 400 includes receiving a downlink transmission, with the analog beamforming or without the analog beamforming, based at least in part on the analog downlink beam weight.

In a seventh aspect, alone or in combination with one or more of the first through sixth aspects, process 400 includes transmitting an uplink transmission, with the analog beamforming or without the analog beamforming, based at least in part on the analog uplink beam weight.

In an eighth aspect, alone or in combination with one or more of the first through seventh aspects, the analog beamforming communication is via one or more discrete FR1-based antennas associated with the UE.

In a ninth aspect, alone or in combination with one or more of the first through eighth aspects, the analog beamforming communication is via one or more first FR1-style antennas associated with the UE, and the one or more FR1-style antennas are at an FR3.

Although FIG. 4 shows example blocks of process 400, in some aspects, process 400 may include additional blocks, fewer blocks, different blocks, or differently arranged blocks than those depicted in FIG. 4. Additionally, or alternatively, two or more of the blocks of process 400 may be performed in parallel.

FIG. 5 is a diagram illustrating an example process 500 performed, for example, at a network node or an apparatus of a network node, in accordance with the present disclosure. Example process 500 is an example where the apparatus or the network node (e.g., network node 110) performs operations associated with performing downlink or uplink analog beamforming communications with discrete antennas.

As shown in FIG. 5, in some aspects, process 500 may include receiving a set of SRSs in an uplink direction (block 510). For example, the network node (e.g., using reception component 702 and/or communication manager 706, depicted in FIG. 7) may receive a set of SRSs in an uplink direction, as described above.

As further shown in FIG. 5, in some aspects, process 500 may include transmitting a plurality of downlink reference signals in accordance with a downlink beamforming, wherein the plurality of downlink reference signals are precoded using a precoder based at least in part on the set of SRSs (block 520). For example, the network node (e.g., using transmission component 704 and/or communication manager 706, depicted in FIG. 7) may transmit a plurality of downlink reference signals in accordance with a downlink beamforming, wherein the plurality of downlink reference signals are precoded using a precoder based at least in part on the set of SRSs, as described above.

As further shown in FIG. 5, in some aspects, process 500 may include performing an analog beamforming communication based at least in part on an analog downlink beam weight or an analog uplink beam weight, wherein the analog downlink beam weight is for the downlink beamforming and is based at least in part on a CIR derived from the plurality of downlink reference signals, and the analog uplink beam weight is based at least in part on the analog downlink beam weight (block 530). For example, the network node (e.g., using communication manager 706, depicted in FIG. 7) may perform an analog beamforming communication based at least in part on an analog downlink beam weight or an analog uplink beam weight, wherein the analog downlink beam weight is for the downlink beamforming and is based at least in part on a CIR derived from the plurality of downlink reference signals, and the analog uplink beam weight is based at least in part on the analog downlink beam weight, as described above.

Process 500 may include additional aspects, such as any single aspect or any combination of aspects described below and/or in connection with one or more other processes described elsewhere herein.

In a first aspect, process 500 includes transmitting an SRS configuration that indicates an SRS periodicity, wherein the SRS periodicity is based at least in part on a dynamics of a channel between the network node and a UE, and the set of SRSs are received in accordance with the SRS configuration.

In a second aspect, alone or in combination with the first aspect, process 500 includes receiving a downlink reference signal configuration request based at least in part on a channel condition and an uplink-downlink channel disparity, wherein the downlink reference signal configuration request indicates a number of ports and a requested periodicity, wherein the plurality of downlink reference signals are transmitted in accordance with a downlink reference signal configuration, and the downlink reference signal configuration is based at least in part on the downlink reference signal configuration request.

In a third aspect, alone or in combination with one or more of the first and second aspects, process 500 includes identifying the precoder based at least in part on the set of SRSs.

In a fourth aspect, alone or in combination with one or more of the first through third aspects, the analog uplink beam weight is from a lookup table based at least in part on the analog downlink beam weight.

In a fifth aspect, alone or in combination with one or more of the first through fourth aspects, process 500 includes transmitting a downlink transmission, with the analog beamforming or without the analog beamforming, based at least in part on the analog downlink beam weight.

In a sixth aspect, alone or in combination with one or more of the first through fifth aspects, process 500 includes receiving an uplink transmission, with the analog beamforming or without the analog beamforming, based at least in part on the analog uplink beam weight.

In a seventh aspect, alone or in combination with one or more of the first through sixth aspects, the analog beamforming communication is via one or more discrete FR1-based antennas associated with a UE.

In an eighth aspect, alone or in combination with one or more of the first through seventh aspects, the analog beamforming communication is via one or more FR1-style antennas associated with a UE, and the one or more FR1-style antennas are at an FR3.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram of an example apparatus 600 for wireless communication, in accordance with the present disclosure. The apparatus 600 may be a UE, or a UE may include the apparatus 600. In some aspects, the apparatus 600 includes a reception component 602, a transmission component 604, and/or a communication manager 606, which may be in communication with one another (for example, via one or more buses and/or one or more other components). In some aspects, the communication manager 606 is the communication manager 150 described in connection with FIG. 1. As shown, the apparatus 600 may communicate with another apparatus 608, such as a UE or a network node (such as a CU, a DU, an RU, or a base station), using the reception component 602 and the transmission component 604. The communication manager 606 may be included in, or implemented via, a processing system (for example, the processing system 140 described in connection with FIG. 1) of the UE.

In some aspects, the apparatus 600 may be configured to perform one or more operations described herein in connection with FIG. 3. Additionally, or alternatively, the apparatus 600 may be configured to perform one or more processes described herein, such as process 400 of FIG. 4, or a combination thereof. In some aspects, the apparatus 600 and/or one or more components shown in FIG. 6 may include one or more components of the UE described in connection with FIG. 1. Additionally, or alternatively, one or more components shown in FIG. 6 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 602 may receive communications, such as reference signals, control information, data communications, or a combination thereof, from the apparatus 608. The reception component 602 may provide received communications to one or more other components of the apparatus 600. In some aspects, the reception component 602 may perform signal processing on the received communications, and may provide the processed signals to the one or more other components of the apparatus 600. In some aspects, the reception component 602 may include one or more components of the UE described above in connection with FIG. 1, such as a radio, one or more RF chains, one or more transceivers, or one or more modems, each of which may in turn be coupled with one or more antennas of the UE.

The transmission component 604 may transmit communications, such as reference signals, control information, data communications, or a combination thereof, to the apparatus 608. In some aspects, one or more other components of the apparatus 600 may generate communications and may provide the generated communications to the transmission component 604 for transmission to the apparatus 608. In some aspects, the transmission component 604 may perform signal processing on the generated communications, and may transmit the processed signals to the apparatus 608. In some aspects, the transmission component 604 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 604 may be co-located with the reception component 602.

The communication manager 606 may support operations of the reception component 602 and/or the transmission component 604. For example, the communication manager 606 may receive information associated with configuring reception of communications by the reception component 602 and/or transmission of communications by the transmission component 604. Additionally, or alternatively, the communication manager 606 may generate and/or provide control information to the reception component 602 and/or the transmission component 604 to control reception and/or transmission of communications.

The transmission component 604 may transmit a set of SRSs in an uplink direction. The reception component 602 may receive a plurality of downlink reference signals in accordance with a downlink beamforming, wherein the plurality of downlink reference signals are precoded using a precoder based at least in part on the set of SRSs. The communication manager 606 may perform, via one or more discrete antennas, an analog beamforming communication based at least in part on an analog downlink beam weight or an analog uplink beam weight, wherein the analog downlink beam weight is for the downlink beamforming and is based at least in part on a CIR derived from the plurality of downlink reference signals, and wherein the analog uplink beam weight is derived based at least in part on the analog downlink beam weight.

The reception component 602 may receive an SRS configuration that indicates an SRS periodicity, wherein the SRS periodicity is based at least in part on a dynamics of a channel between the UE and a network node, and the set of SRSs are transmitted in accordance with the SRS configuration. The transmission component 604 may transmit a downlink reference signal configuration request based at least in part on a channel condition and an uplink-downlink channel disparity, wherein the downlink reference signal configuration request indicates a number of ports and a requested periodicity, wherein the plurality of downlink reference signals are received in accordance with a downlink reference signal configuration, and the downlink reference signal configuration is based at least in part on the downlink reference signal configuration request.

The communication manager 606 may identify the CIR associated with the plurality of downlink reference signals. The communication manager 606 may identify the analog downlink beam weight for the downlink beamforming based at least in part on the CIR, wherein the analog downlink beam weight is associated with the analog beamforming communication on a downlink. The communication manager 606 may identify, from a lookup table or using an uplink-downlink calibration procedure, the analog uplink beam weight based at least in part on the analog downlink beam weight, wherein the analog uplink beam weight is associated with the analog beamforming communication on an uplink.

The number and arrangement of components shown in FIG. 6 are provided as an example. In practice, there may be additional components, fewer components, different components, or differently arranged components than those shown in FIG. 6. Furthermore, two or more components shown in FIG. 6 may be implemented within a single component, or a single component shown in FIG. 6 may be implemented as multiple, distributed components. Additionally, or alternatively, a set of (one or more) components shown in FIG. 6 may perform one or more functions described as being performed by another set of components shown in FIG. 6.

FIG. 7 is a diagram of an example apparatus 700 for wireless communication, in accordance with the present disclosure. The apparatus 700 may be a network node, or a network node may include the apparatus 700. In some aspects, the apparatus 700 includes a reception component 702, a transmission component 704, and/or a communication manager 706, which may be in communication with one another (for example, via one or more buses and/or one or more other components). In some aspects, the communication manager 706 is the communication manager 155 described in connection with FIG. 1. As shown, the apparatus 700 may communicate with another apparatus 708, such as a UE or a network node (such as a CU, a DU, an RU, or a base station), using the reception component 702 and the transmission component 704. The communication manager 706 may be included in, or implemented via, a processing system (for example, the processing system 145 described in connection with FIG. 1) of the network node.

In some aspects, the apparatus 700 may be configured to perform one or more operations described herein in connection with FIG. 3. Additionally, or alternatively, the apparatus 700 may be configured to perform one or more processes described herein, such as process 500 of FIG. 5, or a combination thereof. In some aspects, the apparatus 700 and/or one or more components shown in FIG. 7 may include one or more components of the network node described in connection with FIG. 1. Additionally, or alternatively, one or more components shown in FIG. 7 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 702 may receive communications, such as reference signals, control information, data communications, or a combination thereof, from the apparatus 708. The reception component 702 may provide received communications to one or more other components of the apparatus 700. In some aspects, the reception component 702 may perform signal processing on the received communications, and may provide the processed signals to the one or more other components of the apparatus 700. In some aspects, the reception component 702 may include one or more components of the network node described above in connection with FIG. 1, such as a radio, one or more RF chains, one or more transceivers, or one or more modems, each of which may in turn be coupled with one or more antennas of the network node. In some aspects, the reception component 702 and/or the transmission component 704 may include or may be included in a network interface. The network interface may be configured to obtain and/or output signals for the apparatus 700 via one or more communications links, such as a backhaul link, a midhaul link, and/or a fronthaul link.

The transmission component 704 may transmit communications, such as reference signals, control information, data communications, or a combination thereof, to the apparatus 708. In some aspects, one or more other components of the apparatus 700 may generate communications and may provide the generated communications to the transmission component 704 for transmission to the apparatus 708. In some aspects, the transmission component 704 may perform signal processing on the generated communications, and may transmit the processed signals to the apparatus 708. In some aspects, the transmission component 704 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 704 may be co-located with the reception component 702.

The communication manager 706 may support operations of the reception component 702 and/or the transmission component 704. For example, the communication manager 706 may receive information associated with configuring reception of communications by the reception component 702 and/or transmission of communications by the transmission component 704. Additionally, or alternatively, the communication manager 706 may generate and/or provide control information to the reception component 702 and/or the transmission component 704 to control reception and/or transmission of communications.

The reception component 702 may receive a set of SRSs in an uplink direction. The transmission component 704 may transmit a plurality of downlink reference signals in accordance with a downlink beamforming, wherein the plurality of downlink reference signals are precoded using a precoder based at least in part on the set of SRSs. The communication manager 706 may perform an analog beamforming communication based at least in part on an analog downlink beam weight or an analog uplink beam weight, wherein the analog downlink beam weight is for the downlink beamforming and is based at least in part on a CIR derived from the plurality of downlink reference signals, and the analog uplink beam weight is based at least in part on the analog downlink beam weight.

The transmission component 704 may transmit an SRS configuration that indicates an SRS periodicity, wherein the SRS periodicity is based at least in part on a dynamics of a channel between the network node and a UE, and the set of SRSs are received in accordance with the SRS configuration. The reception component 702 may receive a downlink reference signal configuration request based at least in part on a channel condition and an uplink-downlink channel disparity, wherein the downlink reference signal configuration request indicates a number of ports and a requested periodicity, wherein the plurality of downlink reference signals are transmitted in accordance with a downlink reference signal configuration, and the downlink reference signal configuration is based at least in part on the downlink reference signal configuration request. The communication manager 706 may identify the precoder based at least in part on the set of SRSs.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

The following provides an overview of some Aspects of the present disclosure:

Aspect 1: A method of wireless communication performed by a user equipment (UE), comprising: transmitting a set of sounding reference signals (SRSs) in an uplink direction; receiving a plurality of downlink reference signals in accordance with a downlink beamforming, wherein the plurality of downlink reference signals are precoded using a precoder based at least in part on the set of SRSs; and performing, via one or more discrete antennas, an analog beamforming communication based at least in part on an analog downlink beam weight or an analog uplink beam weight, wherein the analog downlink beam weight is for the downlink beamforming and is based at least in part on a CIR derived from the plurality of downlink reference signals, and wherein the analog uplink beam weight is derived based at least in part on the analog downlink beam weight.

Aspect 2: The method of Aspect 1, further comprising: receiving an SRS configuration that indicates an SRS periodicity, wherein the SRS periodicity is based at least in part on a dynamics of a channel between the UE and a network node, and wherein the set of SRSs are transmitted in accordance with the SRS configuration.

Aspect 3: The method of any of Aspects 1-2, wherein the set of SRSs are transmitted with analog beamforming.

Aspect 4: The method of any of Aspects 1-3, wherein the set of SRSs are transmitted without analog beamforming.

Aspect 5: The method of any of Aspects 1-4, further comprising: transmitting a downlink reference signal configuration request based at least in part on a channel condition and an uplink-downlink channel disparity, wherein the downlink reference signal configuration request indicates a number of ports and a requested periodicity, wherein the plurality of downlink reference signals are received in accordance with a downlink reference signal configuration, and wherein the downlink reference signal configuration is based at least in part on the downlink reference signal configuration request.

Aspect 6: The method of any of Aspects 1-5, further comprising: identifying the CIR associated with the plurality of downlink reference signals; identifying the analog downlink beam weight for the downlink beamforming based at least in part on the CIR, wherein the analog downlink beam weight is associated with the analog beamforming communication on a downlink; and identifying, from a lookup table or using an uplink-downlink calibration procedure, the analog uplink beam weight based at least in part on the analog downlink beam weight, wherein the analog uplink beam weight is associated with the analog beamforming communication on an uplink.

Aspect 7: The method of any of Aspects 1-6, wherein performing the analog beamforming communication comprises: receiving a downlink transmission, with the analog beamforming or without the analog beamforming, based at least in part on the analog downlink beam weight.

Aspect 8: The method of any of Aspects 1-7, wherein performing the analog beamforming communication comprises: transmitting an uplink transmission, with the analog beamforming or without the analog beamforming, based at least in part on the analog uplink beam weight.

Aspect 9: The method of any of Aspects 1-8, wherein the analog beamforming communication is via one or more discrete frequency range one (FR1)-based antennas associated with the UE.

Aspect 10: The method of any of Aspects 1-9, wherein the analog beamforming communication is via one or more frequency range one(FR1)-style antennas associated with the UE, and wherein the one or more FR1-style antennas are at a frequency range three (FR3).

Aspect 11: A method of wireless communication performed by a network node, comprising: receiving a set of sounding reference signals (SRSs) in an uplink direction; transmitting a plurality of downlink reference signals in accordance with a downlink beamforming, wherein the plurality of downlink reference signals are precoded using a precoder based at least in part on the set of SRSs; and performing an analog beamforming communication based at least in part on an analog downlink beam weight or an analog uplink beam weight, wherein the analog downlink beam weight is for the downlink beamforming and is based at least in part on a channel impulse response (CIR) derived from the plurality of downlink reference signals, and wherein the analog uplink beam weight is derived based at least in part on the analog downlink beam weight.

Aspect 12: The method of Aspect 11, further comprising: transmitting an SRS configuration that indicates an SRS periodicity, wherein the SRS periodicity is based at least in part on a dynamics of a channel between the network node and a user equipment (UE), and wherein the set of SRSs are received in accordance with the SRS configuration.

Aspect 13: The method of any of Aspects 11-12, further comprising: receiving a downlink reference signal configuration request based at least in part on a channel condition and an uplink-downlink channel disparity, wherein the downlink reference signal configuration request indicates a number of ports and a requested periodicity, wherein the plurality of downlink reference signals are transmitted in accordance with a downlink reference signal configuration, and wherein the downlink reference signal configuration is based at least in part on the downlink reference signal configuration request.

Aspect 14: The method of any of Aspects 11-13, further comprising: identifying the precoder based at least in part on the set of SRSs.

Aspect 15: The method of any of Aspects 11-14, wherein the analog uplink beam weight is from a lookup table based at least in part on the analog downlink beam weight.

Aspect 16: The method of any of Aspects 11-15, wherein performing the analog beamforming communication comprises: transmitting a downlink transmission, with the analog beamforming or without the analog beamforming, based at least in part on the analog downlink beam weight.

Aspect 17: The method of any of Aspects 11-16, wherein performing the analog beamforming communication comprises: receiving an uplink transmission, with the analog beamforming or without the analog beamforming, based at least in part on the analog uplink beam weight.

Aspect 18: The method of any of Aspects 11-17, wherein the analog beamforming communication is via one or more discrete frequency range one (FR1)-based antennas associated with a user equipment (UE).

Aspect 19: The method of any of Aspects 11-18, wherein the analog beamforming communication is via one or more frequency range one (FR1)-style antennas associated with a user equipment (UE), and wherein the one or more FR1-style antennas are at a frequency range three (FR3).

Aspect 20: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-19.

Aspect 21: An apparatus for wireless communication at a device, the apparatus comprising one or more memories and one or more processors coupled to the one or more memories, the one or more processors configured to cause the device to perform the method of one or more of Aspects 1-19.

Aspect 22: An apparatus for wireless communication, the apparatus comprising at least one means for performing the method of one or more of Aspects 1-19.

Aspect 23: A non-transitory computer-readable medium storing code for wireless communication, the code comprising instructions executable by one or more processors to perform the method of one or more of Aspects 1-19.

Aspect 24: A non-transitory computer-readable medium storing a set of instructions for wireless communication, the set of instructions comprising one or more instructions that, when executed by one or more processors of a device, cause the device to perform the method of one or more of Aspects 1-19.

Aspect 25: A device for wireless communication, the device comprising a processing system that includes one or more processors and one or more memories coupled with the one or more processors, the processing system configured to cause the device to perform the method of one or more of Aspects 1-19.

Aspect 26: An apparatus for wireless communication at a device, the apparatus comprising one or more memories and one or more processors coupled to the one or more memories, the one or more processors individually or collectively configured to cause the device to perform the method of one or more of Aspects 1-19.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories; and
one or more processors, coupled to the one or more memories, configured to cause the UE to:
transmit a set of sounding reference signals (SRSs) in an uplink direction;
receive a plurality of downlink reference signals in accordance with a downlink beamforming, wherein the plurality of downlink reference signals are precoded using a precoder based at least in part on the set of SRSs; and
perform, via one or more discrete antennas, an analog beamforming communication based at least in part on an analog downlink beam weight or an analog uplink beam weight, wherein the analog downlink beam weight is for the downlink beamforming and is based at least in part on a channel impulse response (CIR) derived from the plurality of downlink reference signals, and wherein the analog uplink beam weight is derived based at least in part on the analog downlink beam weight.

2. The apparatus of claim 1, wherein the one or more processors are further configured to cause the UE to:
receive an SRS configuration that indicates an SRS periodicity, wherein the SRS periodicity is based at least in part on a dynamics of a channel between the UE and a network node, and wherein the set of SRSs are transmitted in accordance with the SRS configuration.

3. The apparatus of claim 1, wherein the one or more processors are configured to transmit the set of SRSs with analog beamforming.

4. The apparatus of claim 1, wherein the one or more processors are configured to transmit the set of SRSs without analog beamforming.

5. The apparatus of claim 1, wherein the one or more processors are further configured to cause the UE to:
transmit a downlink reference signal configuration request based at least in part on a channel condition and an uplink-downlink channel disparity, wherein the downlink reference signal configuration request indicates a number of ports and a requested periodicity, wherein the plurality of downlink reference signals are received in accordance with a downlink reference signal configuration, and wherein the downlink reference signal configuration is based at least in part on the downlink reference signal configuration request.

6. The apparatus of claim 1, wherein the one or more processors are further configured to cause the UE to:
identify the CIR associated with the plurality of downlink reference signals;
identify the analog downlink beam weight for the downlink beamforming based at least in part on the CIR, wherein the analog downlink beam weight is associated with the analog beamforming communication on a downlink; and
identify, from a lookup table or using an uplink-downlink calibration procedure, the analog uplink beam weight based at least in part on the analog downlink beam weight, wherein the analog uplink beam weight is associated with the analog beamforming communication on an uplink.

7. The apparatus of claim 1, wherein the one or more processors, to perform the analog beamforming communication, are configured to cause the UE to:
receive a downlink transmission, with the analog beamforming or without the analog beamforming, based at least in part on the analog downlink beam weight.

8. The apparatus of claim 1, wherein the one or more processors, to perform the analog beamforming communication, are configured to cause the UE to:
transmit an uplink transmission, with the analog beamforming or without the analog beamforming, based at least in part on the analog uplink beam weight.

9. The apparatus of claim 1, wherein the analog beamforming communication is via one or more discrete frequency range one (FR1)-based antennas associated with the UE.

10. The apparatus of claim 1, wherein the analog beamforming communication is via one or more frequency range one (FR1)-style antennas associated with the UE, and wherein the one or more FR1-style antennas are at a frequency range three (FR3).

11. An apparatus for wireless communication at a network node, comprising:
one or more memories; and
one or more processors, coupled to the one or more memories, configured to cause the network node to:
receive a set of sounding reference signals (SRSs) in an uplink direction;
transmit a plurality of downlink reference signals in accordance with a downlink beamforming, wherein the plurality of downlink reference signals are precoded using a precoder based at least in part on the set of SRSs; and
perform an analog beamforming communication based at least in part on an analog downlink beam weight or an analog uplink beam weight, wherein the analog downlink beam weight is for the downlink beamforming and is based at least in part on a channel impulse response (CIR) derived from the plurality of downlink reference signals, and wherein the analog uplink beam weight is derived based at least in part on the analog downlink beam weight.

12. The apparatus of claim 11, wherein the one or more processors are further configured to cause the network node to:
transmit an SRS configuration that indicates an SRS periodicity, wherein the SRS periodicity is based at least in part on a dynamics of a channel between the network node and a user equipment (UE), and wherein the set of SRSs are received in accordance with the SRS configuration.

13. The apparatus of claim 11, wherein the one or more processors are further configured to cause the network node to:
receive a downlink reference signal configuration request based at least in part on a channel condition and an uplink-downlink channel disparity, wherein the downlink reference signal configuration request indicates a number of ports and a requested periodicity, wherein the plurality of downlink reference signals are transmitted in accordance with a downlink reference signal configuration, and wherein the downlink reference signal configuration is based at least in part on the downlink reference signal configuration request.

14. The apparatus of claim 11, wherein the one or more processors are further configured to cause the network node to:
identify the precoder based at least in part on the set of SRSs.

15. The apparatus of claim 11, wherein the analog uplink beam weight is from a lookup table based at least in part on the analog downlink beam weight.

16. The apparatus of claim 11, wherein the one or more processors, to perform the analog beamforming communication, are configured to cause the network node to:
transmit a downlink transmission, with the analog beamforming or without the analog beamforming, based at least in part on the analog downlink beam weight.

17. The apparatus of claim 11, wherein the one or more processors, to perform the analog beamforming communication, are configured to cause the network node to:
receive an uplink transmission, with the analog beamforming or without the analog beamforming, based at least in part on the analog uplink beam weight.

18. The apparatus of claim 11, wherein the analog beamforming communication is via one or more discrete frequency range one (FR1)-based antennas associated with a user equipment (UE).

19. The apparatus of claim 11, wherein the analog beamforming communication is via one or more frequency range one (FR1)-style antennas associated with a user equipment (UE), and wherein the one or more FR1-style antennas are at a frequency range three (FR3).

20. A method of wireless communication performed by a user equipment (UE), comprising:
transmitting a set of sounding reference signals (SRSs) in an uplink direction;
receiving a plurality of downlink reference signals in accordance with a downlink beamforming, wherein the plurality of downlink reference signals are precoded using a precoder based at least in part on the set of SRSs; and
performing, via one or more discrete antennas, an analog beamforming communication based at least in part on an analog downlink beam weight or an analog uplink beam weight, wherein the analog downlink beam weight is for the downlink beamforming and is based at least in part on a channel impulse response (CIR) derived from the plurality of downlink reference signals, and wherein the analog uplink beam weight is derived based at least in part on the analog downlink beam weight.
